(19) United States
(12) Patent Application Publication
(10) Pub. No.: US 2004/0175489 A1
(43) Pub. Date: Sep. 9, 2004

(54) Fast flavor release coating for confectionery

(75) Inventors: James C. Clark, St. Louis, MO (US); Chungsea A. Shen, Deerfield, IL (US)

Correspondence Address: WRIGLEY & DREYFUS 28455, BRINKS HOFER GILSON & LIONE, P.O. BOX 10395, CHICAGO, IL, 60610, US

(73) Assignee: Wm. Wrigley Jr. Company

(21) Appl. No.: 10/792,117

(22) Filed: Mar. 2, 2004

Related U.S. Application Data
(60) Provisional application No. 60/451,904, filed on Mar. 3, 2003.

(51) Int. Cl. A23L 1/30

(52) U.S. Cl. 426/660

(57) ABSTRACT

A confectionery product has an outer dry powder coating layer that includes a flavor encapsulated with a water-soluble encapsulant. The encapsulated flavor, being included in the outermost coating of the product, is immediately released when the product is placed in the mouth, giving a very quick initial flavor impact.

### REFERENCE TO EARLIER FILED APPLICATION

The present application claims the benefit of the filing date under 35 U.S.C. § 119(e) of Provisional U.S. Patent Application Serial No. 60/451,904, filed Mar. 3, 2003, which is hereby incorporated by reference in its entirety.

### BACKGROUND OF THE INVENTION

The present invention relates to confectionery products, and particularly to confectionery products that are coated with a fast flavor release coating.

Numerous coated confectionaries are available. Many confectionaries, such as chewing gum balls, have a hard shell sugar coating. Multiple layers of coatings are also known. For example, a compound coating may have a hard shell coating applied over it. Also, products coated with sugar or some other powder may first be coated with a liquid precoating mass. Particularly with compressed tablets, the precoating masses are usually made with a gum arabic solution followed by drying with a gum arabic powder or other powders to form a seal on the surface of the tablet. Also, precoating solutions with powder additions are used between layers of coating to give a fast buildup of coating layers.

In general, multiple coatings are used to coat chewing gum or other confections, tablets and other products. Some coated confections have flavor in the coating layers. With multiple coatings, many products that use flavor in the coating have a shell that gives the product a unique crunchy sensation when bitten into. The flavor in the coatings is typically added by applying several coatings of syrup without flavor, drying each coat between applications, and then a syrup with flavor is applied, followed by additional applications of coating syrup without flavor. Such products have become popular, and provide a pleasant flavor. However, there is still room for improvement. For example, many products may produce fairly uniform flavor impact over the duration of the time the product is in the mouth. In the typical flavored hard shell coating, the flavor is not immediately available. The flavor in the coating is released only as the layers of coating are dissolved or the product is chewed. Some times it would be desirable if a confectionery product had a fast flavor release impact that gives an intense flavor as soon as the product is placed in the mouth. An improvement is therefore needed to produce a flavored coating with a fast impact to give a “kick” flavor to a confectionery, without the additional layers of coatings used in more conventional type products.

### SUMMARY OF THE INVENTION

A fast flavor release coating for confectionery has been invented. With the coating, the product has a very quick, high impact flavor as soon as the product is placed in the mouth.

In a first aspect, the invention is a coated confectionery product comprising: a confectionery center and a powder coating layer on the center, the powder coating comprising a flavor encapsulated in a water-soluble encapsulant and comprising the outermost layer of the product.

In a second aspect, the invention is a method of producing a powder coated confectionery product comprising the steps of: providing a center; forming a binder layer over the center by applying a liquid syrup; and applying a powder coating over the binder layer, the powder coating comprising a flavor encapsulated in a water-soluble encapsulant.

In the preferred embodiment of the invention, a conventional tablet is coated with a solution containing gum arabic and a bulk sweetener to provide an adhesive to the surface of the tablet. After the liquid is spread on the surface, a powdered mixture of bulk sweetener, high intensity sweetener and spray dried flavor is dusted onto the surface of the tablet in a coating pan. The spray dried flavor is at a very high level of the powder mixture, preferably at least 10% of the mixture, and is dusted onto the surface of the tablet. Sufficient powder is added to dry the surface without any additional air drying. No additional coating layers are applied.

The preferred product is coated in a manner of minutes and removed from the panning equipment after only a few more minutes panning. No further processing is needed and the product has a fast, intense flavor release immediately as it is put into the mouth. After a few seconds, the flavor level drops off to give a mild flavor from the tablet.

### DETAILED DESCRIPTION OF THE PREFERRED EMBODIMENTS OF THE INVENTION

The confectionery center to which the coating can be applied can be chosen from a wide variety of confectionery materials. The center is preferably a compressed tablet made by conventional means. A compressed tablet is a mixture of base materials, binders, flavors, and lubricants. The base material may be a sugar or a polyol. Among the sugars that may be used are sucrose, dextrose, lactose, maltose, and other common sugars. In addition, base materials may include non-sugar bulking agents. Among these are polyols such as sorbitol, maltitol, mannitol, xylitol, hydrogenated isomaltalose, lactitol, erythritol and combinations thereof. High-intensity sweeteners such as acesulfame K, aspartame, alitame, sucralose, glycyrrhizin, saccharin and cyclamates may also be included with the base materials.

Binders that are commonly used are natural gums and hydrocolloids such as gum arabic, guar gum, agar, alginates, gum tragacanth, gelatin, corn syrup, starches and maltodextrins. Most commonly used binders are gelatin, gum arabic and maltodextrins or corn syrups. When non-sugar polyols such as sorbitol are used as the base material, binders are not needed for binding since many of these polyols are easily compressed to form tablets. In some cases polyols such as sorbitol may also act as a binder and may be combined with sugar to form the base materials for the compressed tablet. Binders usually comprise about 2% to about 8% of the tablet.

Lubricants are used to give good release from the press tooling or die and punches. A variety of lubricants or non-stick agents may be used in a tablet to act as release agents. Some of these are starch, acetylated monoglycerides, waxes, lecithins, emulsifiers, and mono-, di-, or tristearates. The most common of these lubricants are magnesium or calcium stearate and stearic acid. Solid lubricants are added to the tablet composition to help form the tablet and allow for its release from the tablet press. Lubricants usually comprise about 0.5% to about 2% of the tablet. In some instances, low levels of flow agents such as silicon dioxide are added to the tablet composition to help the flow of the mixture into the tablet press.

Flavoring agents are preferably added at a level of about 0.01% to about 2% by weight of the tablet. The flavoring agents may comprise essential oils, synthetic flavors, or mixtures including but not limited to oils derived from plants and fruits such as citrus oils, fruit essences, peppermint oil, spearmint oil, clove oil, oil of wintergreen, anise and the like. Artificial flavoring components are also contemplated for use in tablets of the present invention. Those skilled in the art will recognize that natural and artificial flavoring agents may be combined in any sensorially acceptable blend, and adjusted for taste preferences. All such flavors and flavor blends are contemplated by the present invention.

These same flavors may be spray dried with water-soluble encapsulants such as gum arabic, maltodextrins, modified starches, and hydrocolloids and used in the powder coating at a level of about 10% to about 30% flavor loading. The spray dried flavor can be made by any conventional spray drying process using a water-soluble encapsulant. Preferably the encapsulated flavors will comprise about 20% flavor and about 80% gum arabic. The encapsulated flavor may be different than the flavor used in the tablet or other confectionery center.

Menthol and physiological cooling agents (sometimes referred to as high-intensity coolants) may be added to the tablet as well as to the flavor being encapsulated. When used in the tablet, they will be used at a level of about 0.01% to about 1%. Except for menthol, these cooling agents are preferably preblended with the flavor before being added to the mixture of ingredients used to form the tablet. Menthol may be preblended with the flavor or may be added to the tablet composition mixture in its crystalline form. Typical cooling agents include substituted p-menthane carboxamides, acyclic carboxamides, menthone glycerol ketals, menthyl lactate, menthyl succinate, menthyl glutarate, 2-isopropenyl-5-methylcyclohexanol (also called isopulegol), p-menthane-3,8-diol (also called menthanediol) and 3-1-menthoxypropane-1,2 diol. These cooling agents and flavors are also preferably used in the various coatings of the tablets.

Colors and other additives are also contemplated for use in the tablets and the coatings of this invention.

In some cases, ingredients used for tableting are wet granulated before blending with the flavor and lubricant. Most commonly, however, direct compressible material can be obtained for making the compressed tablet. The base materials are dry blended along with any high-intensity sweeteners before any flavor is added. Liquid flavors and solid flavors are added slowly to the base materials and mixed in a dry material mixer, such as a ribbon mixer or a Hobart mixer. Lastly, the lubricant such as magnesium stearate is added, but not overmixed. Overmixing the mixture with magnesium stearate can reduce lubrication. In general, the final powder mixture is allowed to sit for up to 12 hours before being sent to the tablet press so that its properties will be suitable for tableting, including drying if the mixture is too damp.

Conventional rotary tablet presses are used to produce the preferred tablet. Tablet presses may be obtained from Fette America, 300 Roundhill Dr., Rockaway, N.J.; Stokes Div. of DT Industries, 1500 Grundy's Lane, Bristol, Pa.; or Thomas Engineering, Inc. 575 W. Central Rd., Hoffman Estates, Ill. The basic steps of rotary tablet press operation involve four steps. The first step is to fill the die cavity; the second step is to adjust the fill by removing excess fill; the third step is compression; and the fourth step is ejection of the tablet from the die. In standard production equipment, there is also a precompression step before the final compression and then ejection. Generally, confectionery tablets are about 0.2 to about 2.0 grams in size. Preferably, confectionery tablets should be about 0.5 to about 1.5 grams in size. Most preferably, confectionery tablets should be about 1.0 to 1.2 grams in size.

Another center that may be coated according to the present invention is chewing gum. It is preferred that the gum center first be coated with a hard shell coating, such as disclosed in U.S. Pat. No. 6,350,480, which is hereby incorporated by reference. After the hard shell coating is applied, the binder layer and powder coating of the present invention are applied just as with a tableted center. Of course the gum center can be made by a conventional process or by a tableting process.

The center is coated with an aqueous solution of a bulk sweetener, a binder and water. The binder used in the solution may be any of the binders listed for use in making the tablet. The preferred binder syrup contains about 30-70% water, about 25 to 50% of the bulk sweetener, about 0.1-5% high-intensity sweeteners and about 5-25% gum arabic. The preferred bulk sweetener for a sugarless tablet center would be a polyol, and most preferably hydrogenated isomaltulose, also known as isomalt. The binder syrup is added to the tablets in a coating pan at a level of about 0.2% to about 1.0%, and preferably 0.5%, of the weight of the tablet center. The binder syrup is allowed to spread over the tablets for about a minute and, if necessary, may be stirred vigorously with a paddle in order to give an even spread of syrup.

After the binder syrup is spread over the tablet surface, the powder coating containing flavor is sifted slowly into the turning coating pan. The powder coating comprises at least 50-90% dry bulk sweetener, about 10-49% spray dried flavor, and optionally about 0.1-5% dry high-intensity sweeteners. Preferably, about 60-80% bulk sweetener, about 15-40% spray dried flavor, and optionally about 0.5-3% high-intensity sweetener is used. In the most preferred embodiment, hydrogenated isomaltulose is the bulk sweetener, the spray dried flavor is peppermint or spearmint flavor encapsulated with gum arabic, and the high-intensity sweetener is aspartame or acesulfame K.

Sufficient powder coating is applied to dry the surface of the wetted tablet. This may amount to about 0.5 to about 2% dry material. Thus the finished product will have an added coating layer of about 2%. The tablets are stirred as needed and run for about 0.5 to 1 minute longer. The tablets are removed and no further drying is needed.

This process does not require any air drying steps, and must not use any further additions of liquid syrup after the dry powder coating is applied. Additional liquid coatings would break the encapsulated flavor and negate the fast release of the flavor. Further, the encapsulated flavor must be in the outermost coating layer so as to give an immediate flavor release as the confectionery product is put into the mouth. After this initial “kick” flavor quickly dissipates, the confectionery center remains in the mouth. Preferably the confectionery is a mild, pleasant tasting tablet.

### EXAMPLES

The following formulations were made into elliptical tablets of 1.10 grams each. The flavor in the tablet was a non-spray dried mint flavor. Menthol, coolant and flavor were preblended before use.

| | Example 1 | Example 2 | Example 3 | Example 4 | Example 5 |
|---|---|---|---|---|---|
| Sorbitol | 98.21 | 98.29 | 98.19 | 98.44 | 98.05 |
| Magnesium | 0.98 | 0.98 | 0.98 | 0.98 | 0.98 |
| Stearate | | | | | |
| Acesulfame | 0.02 | 0.02 | 0.02 | 0.02 | 0.02 |
| Aspartame | 0.10 | 0.10 | 0.10 | 0.10 | 0.10 |
| Flavor | 0.33 | 0.33 | 0.45 | 0.24 | 0.29 |
| Menthol | 0.10 | 0.10 | 0.10 | 0.04 | 0.20 |
| Coolant | 0.06 | 0.06 | 0.06 | 0.06 | 0.06 |
| Color | 0.10 | 0.02 | — | — | — |
| Glycyrrhizin | 0.10 | 0.10 | — | 0.12 | 0.20 |
| Powdered | — | — | 0.10* | — | 0.10** |
| Acid | | | | | |
| Total | 100.0 | 100.0 | 100.0 | 100.0 | 100.0 |

*Powdered lactic acid used to modify flavor
**Powdered citric acid used to modify flavor

A 50 kg quantity of these tablets were then added to a coating pan and coated with 275 grams of a solution of 8% gum talha, 32% hydrogenated isomaltulose, and 60% water. The liquid solution was spread over the tablets as they tumbled. In instances where the tablets did not tumble properly, a paddle was used to aid in spreading the liquid syrup. The tablets were tumbled and/or mixed by the paddle for 45 seconds after adding the syrup.

A 946 gram quantity of the following powder mixtures were then added to the coating pan by sifting the powder onto the tablets in the revolving coating pan. The sifter had approximately 1 mm openings.

| | Ex- | | | | |
|---|---|---|---|---|---|
| | ample 1 | Example 2 | Example 3 | Example 4 | Example 5 |
| Hydrogenated | 82.16 | 82.13 | 62.07 | 73.71 | 61.94 |
| Isomaltulose | | | | | |
| Powder | | | | | |
| Spray Dried | 14.33 | 14.33 | 34.42 | 22.66 | 34.80 |
| Mint Flavor | | | | | |
| Gum Talha | 2.08 | 2.08 | 2.08 | 2.01 | 1.81 |
| Acesulfame | 1.43 | 1.43 | 1.43 | 1.44 | 1.45 |
| Powdered | — | — | — | 0.18 | — |
| Glycyrrhizin | | | | | |
| Color | — | 0.03 | — | — | — |
| Total | 100.0 | 100.0 | 100.0 | 100.0 | 100.0 |

After the powder was added, the pan was allowed to run an additional 30 seconds, giving the tablets time to pick up the powder. When the pan was stopped, the contents were unloaded into a plastic bag lined container.

Sensory evaluation of the coated tablets yielded a product that had a fast burst of flavor initially, and then the flavor became milder and pleasant.

In another Example, Example 5 was repeated except that the acesulfame K sweetener was added to the syrup at a level of about 5% of the binder syrup, making a syrup composition of 5% acesulfame K, 8% gum talha, 27% hydrogenated isomaltulose and 60% water, and coated by tumbling to give improved spreading of the sweetener. Acesulfame K sweetener was then not used in the dry coating.

It should be appreciated that the methods and products of the present invention are capable of being incorporated in the form of a variety of embodiments, only a few of which have been illustrated and described above. For example, fruit flavors may be used instead of the mint in the examples. Additional coating layers, such as soft panning layers, chocolate layers and hard coatings can be interposed between the confectionery center and the outer powder coating. The invention may be embodied in other forms without departing from its spirit or essential characteristics. The described embodiments are to be considered in all respects only as illustrative and not restrictive, and the scope of the invention is, therefore, indicated by the appended claims rather than by the foregoing description. All changes that come within the meaning and range of equivalency of the claims are to be embraced within their scope.

1. A coated confectionery product comprising:
a) a confectionery center; and
b) a powder coating layer on the center, the powder coating layer comprising
i) a flavor encapsulated in a water-soluble encapsulant, and
ii) the outermost layer of the product.

2. The coated confectionery product of claim 1 further comprising a binder layer between the center and the powder coating layer.

3. The coated confectionery product of claim 1 wherein the confectionery center comprises a chewing gum product and further comprising a hard shell coating between the chewing gum product center and the powder coating layer.

4. The coated confectionery product of claim 1 wherein the powder coating layer further comprises a bulk sweetener.

5. The coated confectionery product of claim 1 wherein the confectionery center comprises a compressed tablet.

6. The coated confectionery product of claim 5 wherein the compressed tablet includes mint flavor.

7. The coated confectionery product of claim 1 wherein the powder coating layer comprises at least about 10% encapsulated flavor.

8. The coated confectionery product of claim 2 wherein the binder layer comprises a solution of a bulk sweetener and a binder selected from the group consisting of gum talha, gum arabic, maltodextrins, modified starches, hydrocolloids and mixtures thereof.

9. The coated confectionery product of claim 1 wherein the encapsulated flavor is spray dried.

10. The coated confectionery product of claim 1 wherein the powder coating layer comprises about 50% to about 90% dry bulk sweetener and about 10% to about 49% spray dried flavor.

11. The coated confectionery product of claim 10 wherein the powder coating layer further comprises about 0.1% to about 5% dry high-intensity sweetener.

12. The coated confectionery product of claim 11 wherein the high-intensity sweetener is selected from the group consisting of aspartame and acesulfame K.

13. The coated confectionery product of claim 3 wherein the hard shell coating is made from a sugar selected from the group consisting of sucrose, dextrose, maltose and mixtures thereof.

14. The coated confectionery product of claim 3 wherein the hard shell coating is made from a polyol selected from the group consisting of sorbitol, maltitol, xylitol, hydrogenated isomaltalose, lactitol, eyrthritol and mixtures thereof.

15. The coated confectionery product of claim 4 wherein the bulk sweetener comprises a polyol.

16. The coated confectionery product of claim 1 wherein the product is sugarless.

17. The coated confectionery product of claim 15 wherein the bulk sweetener comprises hydrogenated isomaltulose.

18. The coated confectionery product of claim 1 wherein the powder coating layer comprises about 60% to about 80% bulk sweetener.

19. The coated confectionery of claim 1 wherein the powder coating layer comprises about 15% to about 40% spray dried flavor.

20. The coated confectionery product of claim 1 wherein powder coating layer comprises about 0.5% to about 3% high-intensity sweetener.

21. The coated confectionery product of claim 1 wherein the powder coating layer comprises about 0.5% to about 2% by weight of the product.

22. The coated confectionery product of claim 2 wherein the binder layer comprises between about 0.2% and about 1% by weight of the product.

23. The coated confectionery product of claim 3 wherein the hard shell layer comprise about 10% to about 50% by weight of the product.

24. The coated confectionery product of claim 2 wherein the binder layer and powder layer together comprise about 2% of the product.

25. The coated confectionery product of claim 1 wherein the center is between about 0.2 and about 2.0 grams in size.

26. The coated confectionery product of claim 5 wherein the compressed tablet comprises a base material, a binder, a flavoring agent and a lubricant.

27. The coated confectionery product of claim 26 wherein the flavoring agent in the tablet comprises a high-intensity coolant selected from the group consisting of substituted p-menthane carboxamides, acyclic carboxamides, menthone glycerol ketals, menthyl lactate, menthyl succinate, 3-1-menthoxypropane-1,2 diol and mixtures thereof.

28. The coated confectionery product of claim 26 wherein the flavoring agent comprises about 0.01% to about 2% by weight of the tablet.

29. The coated confectionery product of claim 27 wherein the high-intensity coolant comprises about 0.01% to about 1% of the tablet.

30. A confectionery product comprising:
a) a compressed product center comprising
i) a sweetener selected from the group consisting of sucrose, sorbitol and mixtures thereof;
ii) a lubricant; and
iii) flavor, including menthol and a physiological cooling agent;
b) a binder layer covering the product center comprising
i) a sweetener selected from the group consisting of sugars, polyols and mixtures thereof, and
ii) a binder selected from the group consisting of gum arabic, gum talha and mixtures thereof; and
c) a powder coating layer covering the binder layer, the powder coating comprising
i) a spray dried flavor;
ii) a high-intensity sweetener; and
iii) a bulk sweetener selected from the group consisting of sugars, polyols and mixtures thereof.

31. The confectionery product of claim 30 wherein the powder coating layers comprise about 15% to about 40% spray dried flavor, about 60% to about 80% bulk sweetener, and about 0.5% to about 3% high-intensity sweetener.

32. A method of producing a powder coated confectionery product comprising the steps of:
a) providing a center;
b) forming a binder layer over the center by applying a liquid syrup; and
c) applying a powder coating over the binder layer, the powder coating comprising a flavor encapsulated in a water-soluble encapsulant.

33. The method of claim 32 wherein the center is provided by compressing a mixture of a sweetener, binder, lubricant and flavor into a compressed tablet.

34. The method of claim 32 wherein no liquid is applied after the powder coating is applied.

35. The method of claim 32 wherein only one application of syrup is made on the centers, followed by only one application of powder coating.

36. The method of claim 32 wherein the application of the powder is used to dry the syrup, and no air is forced over the centers to dry the syrup.

37. The method of claim 32 wherein the liquid syrup comprises a bulk sweetener and a gum selected from the group consisting of gum arabic, gum talha and mixtures thereof.

38 The method of claim 32 wherein the powder coating comprises about 50% to about 90% dry bulk sweetener and about 10% to about 49% spray dried flavor.

39. The method of claim 38 wherein the powder coating further comprises about 1% to about 5% dry high-intensity sweetener.

40. The coated confectionery product of claim 2 wherein the binder layer comprises about 0.1% to about 5% high-intensity sweetener.
